(19) United States
(12) Patent Application Publication
(10) Pub. No.: US 2010/0156339 A1
(43) Pub. Date: Jun. 24, 2010

(54) Portable solar battery charger

(76) Inventor: Roger L. Hoffman, South Pasadena, CA (US)

Correspondence Address: Oleh J. Zajac, 126 Alta Street, # A, Arcadia, CA, 91006, US

(21) Appl. No.: 12/317,064

(22) Filed: Dec. 18, 2008

(51) Int. Cl. H02J 7/00

(52) U.S. Cl. 320/101

(57) ABSTRACT

A portable solar powered battery charger made of multiple panels which can be deployed in a variety of configurations, depending on the amount and shape of the space available. If less than the total number of panels is deployed to gather solar energy, then the electrical configuration is adjusted accordingly with a multiposition switch. The panels include a set of telescoping legs, which can be extended to keep the charger positioned in a window. The panels of the charger can be rotated apart to be deployed on a curved surface such as an umbrella or a tent.

### FIELD OF THE INVENTION

The present invention relates to portable solar battery chargers.

### BACKGROUND OF THE INVENTION

Since the first demonstration of a solar cell many years ago, there has been a great deal of research and development in the field of solar cells. Much progress has been made in increasing the efficiency of solar cells and decreasing the cost of production. There have been various portable devices made or proposed for increasing the use of solar cells for converting solar energy to electrical energy, but there is a need for a device that is more versatile in terms of how it could be used and deployed in various applications.

### SUMMARY OF THE INVENTION

A portable solar powered battery charger made of multiple panels which can be deployed in a variety of configurations, depending on the amount and shape of the space available. If less than the total number of panels is deployed to gather soar energy, then the electrical configuration is adjusted accordingly with a multiposition switch. The panels include a set of telescoping legs, which can be extended to keep the charger positioned in a window. The panels of the charger can be rotated apart to be deployed on a curved surface such as an umbrella or a tent.

### BRIEF DESCRIPTION OF THE DRAWINGS

FIG. 1 shows a folded portable solar battery charger according to one embodiment of the present invention.

FIG. 2 shows a partially unfolded portable solar battery charger.

FIG. 3 shows one completely unfolded charger.

FIG. 4 shows an alternate embodiment of a charger with extendable legs.

FIG. 5 shows the charger of FIG. 4 with the legs extended to support the charger in the front window of a car.

FIG. 6 shows the first three sections at one end of a charger.

FIG. 7A shows a charger deployed with four panels supported in a briefcase.

FIG. 7B shows front and side views of the charger as configured in FIG. 7A.

FIG. 8A shows a charger deployed with two panels in a window.

FIG. 8B is a front view of the charger as configured in FIG. 8A.

FIG. 8C is a top view of the charger as configured in FIG. 8A.

FIG. 9 is another embodiment of the charger of the present invention in a partially rotated configuration.

FIG. 10 shows a charger in a fully rotated configuration.

FIG. 11 shows a hinge panel of a charger.

FIG. 12 shows a partial view of a hinge panel between two solar panels of a charger.

FIG. 13 shows a cross sectional view of a solar panel and two adjacent solar panels.

FIG. 14A shows a charger deployed on top of an umbrella.

FIG. 14B shows a charger positioned on top of a different kind of umbrella.

FIG. 14C shows a fully rotated charger placed on the top of a canopy.

FIG. 14D shows a top view of a charger located on top of an umbrella.

FIG. 14E shows an unfolded charger on one side of the top of a canopy.

FIG. 14F shows an unfolded charger on the top of a canopy.

### DESCRIPTION OF THE PREFERRED EMBODIMENTS

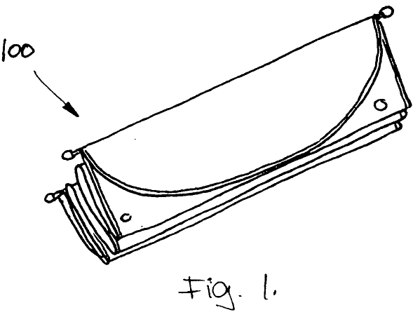

FIG. 1 shows a folded portable solar battery charger 100 according to one embodiment of the present invention. Charger 100 is shown folded into a compact configuration making it easier to store and to protect the solar cells when not in use.

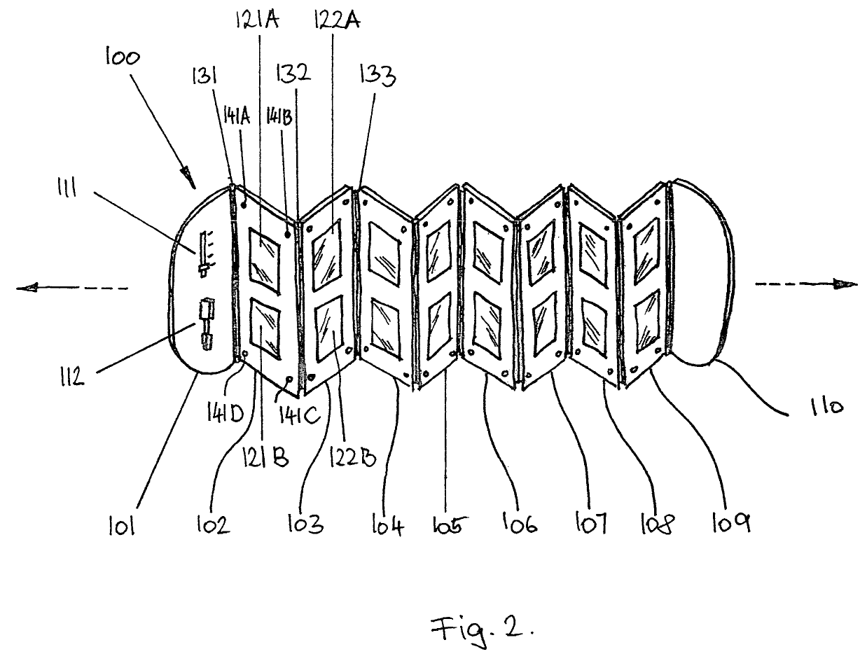

FIG. 2 shows a partially unfolded portable solar battery charger 100 in one exemplary embodiment of the present invention. In this embodiment, charger 100 is made of eight solar panels 102 to 109 with covering end panels 101 and 110 at the ends of charger 100. In other embodiments, charger 100 can have more or less than eight panels. Hinge 131 connects panel 101 to 102 and hinge 132 connects panel 102 to 103. Similarly, each of panels 104 to 109 is connected to each adjacent panel by hinges, as for example 131 and 132. Panel 102 includes solar cells 121A and 121B and fasteners 141A, 141B, 141C and 141D. Adjacent panel 103 includes solar cells 122A and 122B with similar fasteners as on panel 102. Each of the panels 102 to 109 can contain one or more solar cells or solar panels as needed during the design or manufacture of charger 100 to generate a required voltage or current per panel for a particular application. Panel 102 shown with two solar cells 121A and 121B is one exemplary configuration of panel 102.

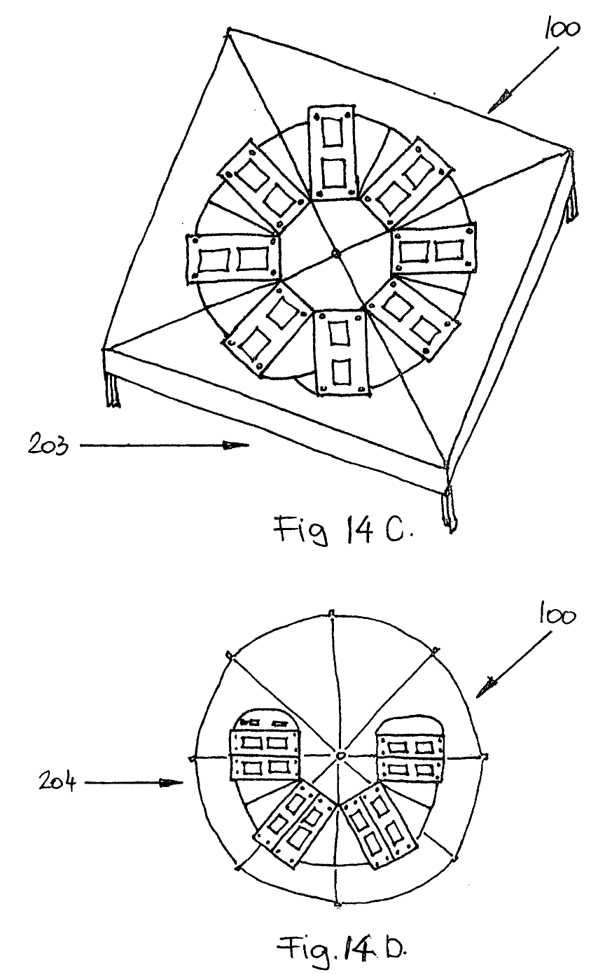

Fasteners 141A, 141B, 141C and 141D can be any of various well known kinds of mechanical connectors or fasteners, such as screws, bolts or rivets made of metal or plastic. If panel 102 is a multilayer panel, such as in the embodiment shown in FIG. 13, fasteners 141A to 141D can provide a way to connect the various layers of the multilayer panel 102 shown in FIG. 13, which will be discussed in more detail with regard to FIG. 13. Fasteners 141A to 141D can also extend through to the back (not shown) of panel 102 and include a way to connect or mate to similar fasteners on the back of adjacent panel 103. Such mating fasteners can provide a way to keep the panels of charger 100 together in a compact configuration, when folded or partially unfolded. The connections between the fasteners 141A to 141D on the back of panel 102 to similar fasteners on the back of panel 103 can be of made of various types, such as mating male to female snap fasteners, mating hook and loop fasteners, mating magnetized fastener heads or other mating types of fasteners.

In other embodiments of charger 100 (not shown), charger 100 can fold in a manner so that the front sides of panels 102 and 103 face each other. In such an embodiment, fasteners 141A to 141D on the front of panel 102 connect or mate with fasteners 141A to 141D on the front of panel 103.

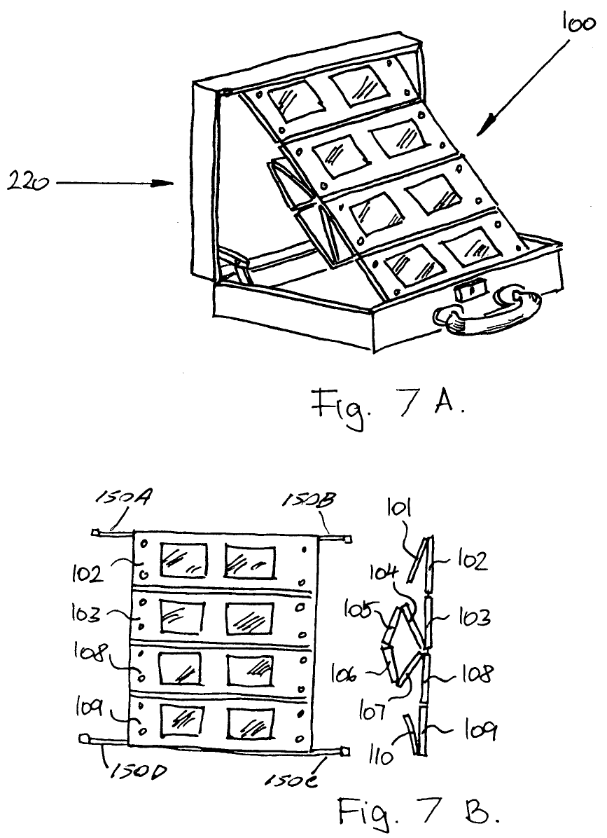

Charger 100 on panel 101 includes multiposition switch 111 and electrical connector 112. Switch 111, also shown in FIG. 6, is shown as having four positions, which corresponds to how charger 100 is unfolded and deployed so that either two, four, six or eight panels are selected for collecting solar energy and converting it to electrical energy. Charger 100 can, for example, be unfolded completely to deploy all eight panels to collect solar energy or partially unfolded for two, four or six panels depending on the space available or the amount of power desired. Electrical connector 112 is the output terminal used to connect a rechargeable battery to be recharged or an electrical device to be powered by charger 100. Charger 100 can also incorporate various configurations of internal rechargeable batteries (not shown) to be recharged by charger 100, with their electrical output at connector 112.

The solar cells and panels of charger 100 can be electrically connected in a variety of parallel, series or parallel/series configurations (not shown) to generate a desired voltage or current output level. Additional electrical switches (not shown) can be designed into the electrical wiring of charger 100 to connect the panels of charger 100 in any desired parallel, series or parallel/series configuration.

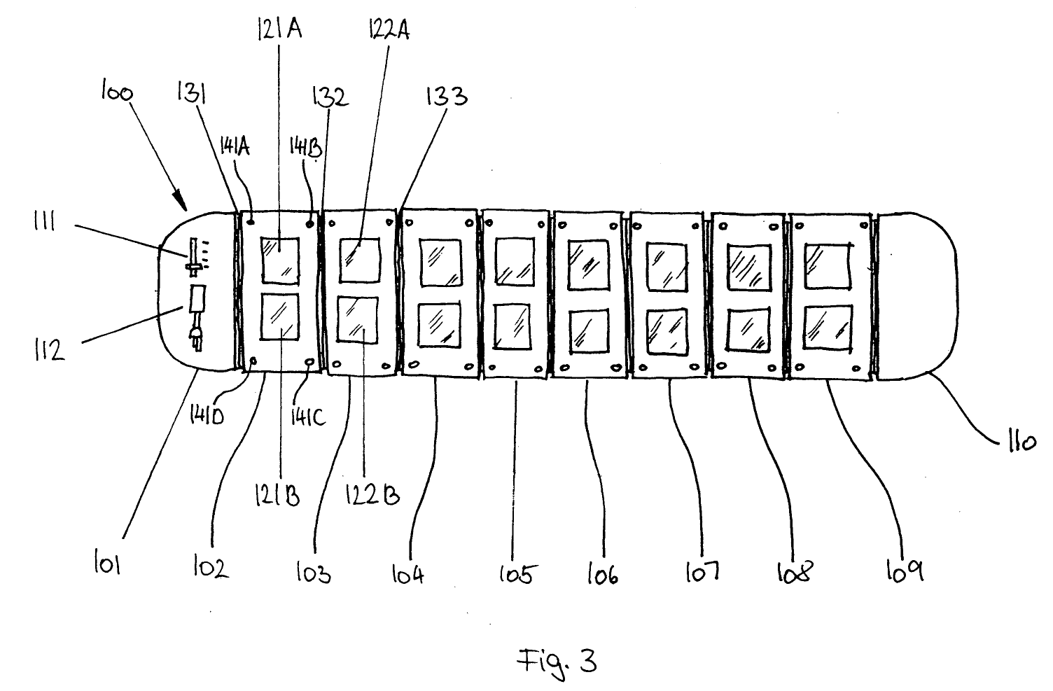

FIG. 3 shows the charger of FIG. 2 completely unfolded for the maximum gathering of solar energy and converting it to electrical energy. In such an unfolded configuration, charger 100 can be positioned on a surface such as a car roof, hood or trunk. Small magnets or magnetic tape on the back side of charger 100 can keep charger 100 positioned on a metal surface of a car or vehicle. If fasteners 141A to 141D are magnetic, then those fasteners can be used to keep charger 100 positioned on a metal surface.

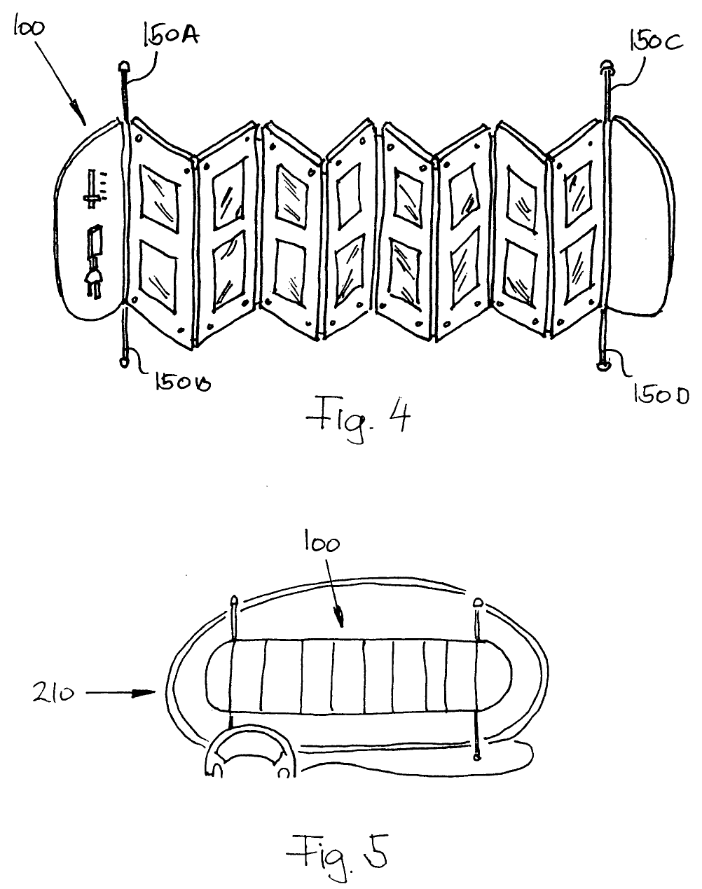

FIG. 4 shows an alternate embodiment of charger 100 with extendable legs 150A-150D. Legs 150A-150D can be made of metal or plastic tubing with rubber tips and can be stored in a collapsed position within charger 100 and can be extended as needed to position and hold charger 100 in a confined space or aperture such as a window.

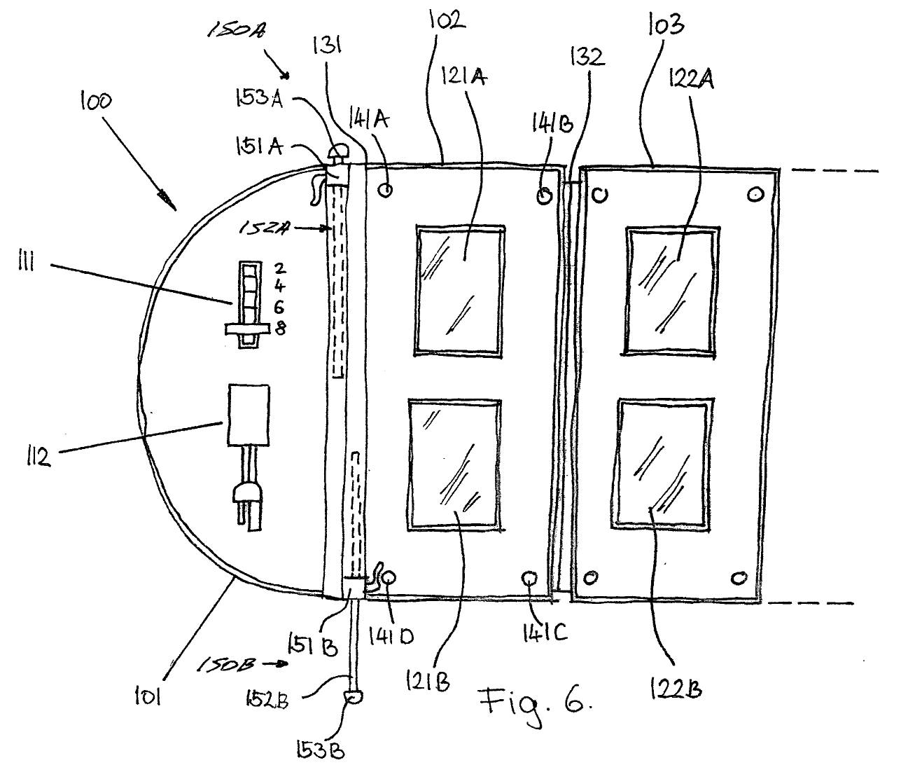

FIG. 5 shows the charger 100 of FIG. 4 with the legs 150A-150D extended to support the charger in the front window 210 of a parked car. Similarly, charger 100 with legs extended could be positioned in the rear window of a parked car or across two side windows of a parked minivan, van or other vehicle with large side windows, such as a sport utility vehicle.

FIG. 6 shows the first three sections at one end of charger 100 with legs 150A and 150B. Leg 150A includes shaft 152A, tip 153A and lock 151A. Leg 150A is shown in a collapsed position and stored in a channel or pocket in cover panel 101. Leg 150B includes shaft 152B, tip 153B and lock 151B, and is shown with lock 151B locking leg 150B in a partially extended position. Shafts 152A and 152B can be made of metal or plastic and can have a circular, square or other geometric cross sectional profile. Tips 153A and 153B can be made of rubber or plastic. Locks 151A and 151B can be any of a variety of cam or lever locks as are commonly used on camera tripod legs. In other embodiments (not shown), legs 150A and 150B can include a spring loaded mechanism, which can help to keep legs 150A and 150B in an extended position, as locks 151A and 151B are locked.

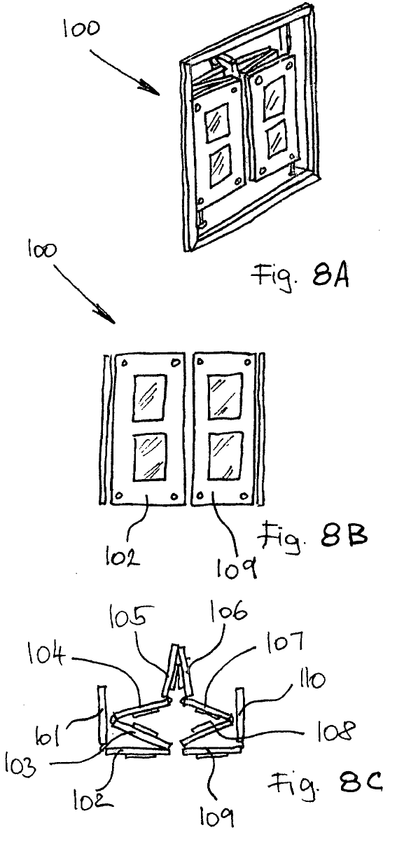

FIG. 7A shows charger 100 deployed with four panels supported in a briefcase 220. Previously discussed legs 150A-150D (not visible) are extended as needed to maintain charger 100 in a stable position at an angle in open briefcase 220.

FIG. 7B shows front and side views of charger 100 as configured in FIG. 7A. Legs 150A and 150B adjacent to panel 102 are partially extended in the space between the two sides of the upper section of open briefcase 220. Similarly, legs 150C and 150D adjacent to panel 109 are partially extended in the space between the two sides of the lower section of open briefcase 220. In the embodiment shown, the panels of charger 100 are folded in such a way as to position the first two panels, 102 and 103 and the last two panels, 108 and 109 to be facing out to collect solar energy. Charger 100 is supported in the position shown in FIG. 7A by legs 150A-150D and by a combination of mechanical or magnetic fasteners between panels 103,104 and 105 and between panels 106, 107 and 108. Additional stability for this configuration of charger 100 can be provided by a hook and loop type fastener along the adjacent edges of panels 103 and 108. For charger 100 to be functioning electrically in a four panel mode, multiposition switch 111 shown in some previous figures has to be selected to be in four panel mode. In an alternate embodiment of charger 100, the electrical wiring of the panels can be configured so as to provide for the inner panels 104, 105, 106 and 107 to be selected to face the sun and generate electricity from sunlight.

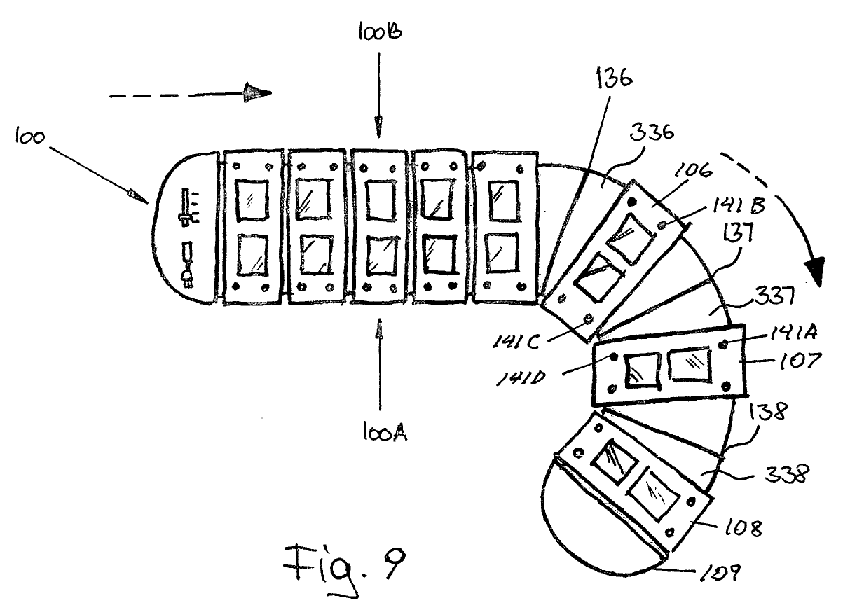

FIG. 8A shows charger 100 deployed with two panels in a window and legs 150A-150D extended to support charger 100. FIG. 8B shows a front view of the charger as configured in FIG. 8A with panels 102 and 109 facing toward the sun to collect solar energy. FIG. 8C is a top view of charger 100 as configured in FIG. 8A, showing how the unused panels of charger 100 are folded behind the deployed panels 102 and 109.

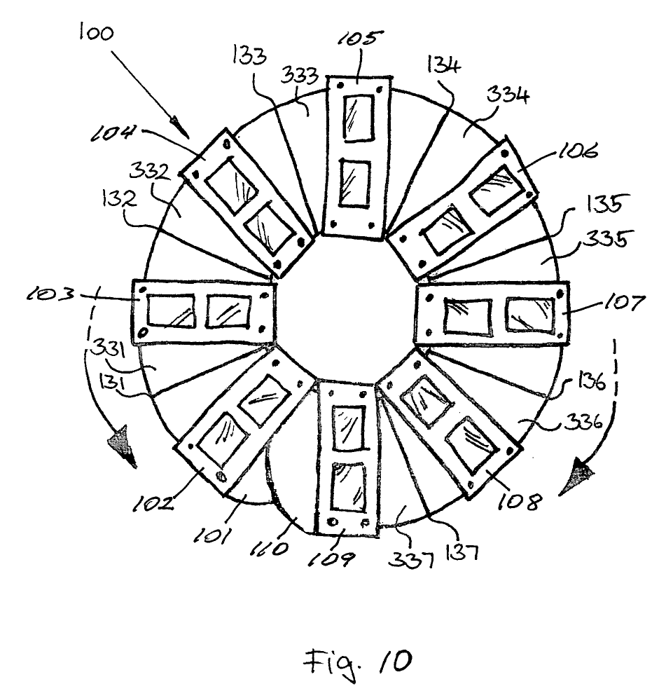

FIG. 9 is another embodiment of charger 100 of the present invention in a partially rotated configuration. For example, hinge panel 336 is attached to panels 106 and 107 in such a manner as to allow panel 107 to rotate away from panel 106. The rotation of panel 107 away from 106 results in an inside curve 100A formed on the bottom edge of charger 100 and an outside curve formed on the top edge 100B of charger 100. Each of panels 102 to 109 is attached to each adjacent panel with hinge panels like 336. Hinge panel 336 is attached to adjacent panel 106 by fasteners 141B and 141C. Hinge panel 336 is also attached to adjacent panel 107 by fasteners 141A and 141D. As panel 107 is moved away from panel 106, rotating about the respective fasteners 141C and 141D, a portion of hinge panel 336 is brought into view. Fastener 141B towards the top end of panel 106 provides a stop to limit the rotation of hinge panel 336. One way to limit the rotation of hinge panel 336 with respect to panel 106 is for a hook or loop (not shown) on the upper left corner of 336 to engage the back of fastener 141B and limit the rotation of hinge panel 336 away from 106. Similarly, the upper right corner of 336 has a hook or loop (not shown) to limit the rotation of panel 107 with respect to hinge panel 336. Hinge panel 336 also includes hinge 236 which provides for the folding of charger 100 into a compact folded configuration for storage or transport as shown in FIG. 1. Similarly, hinge panel 337 is attached to panels 107 and 108 in such a manner as to allow panel 108 to rotate away from panel 107.

In other embodiments of charger 100 (not shown), a hinge panel such as 336 can allow rotation around either the upper fasteners 141A and 141B or around the lower fasteners 141C and 141D.

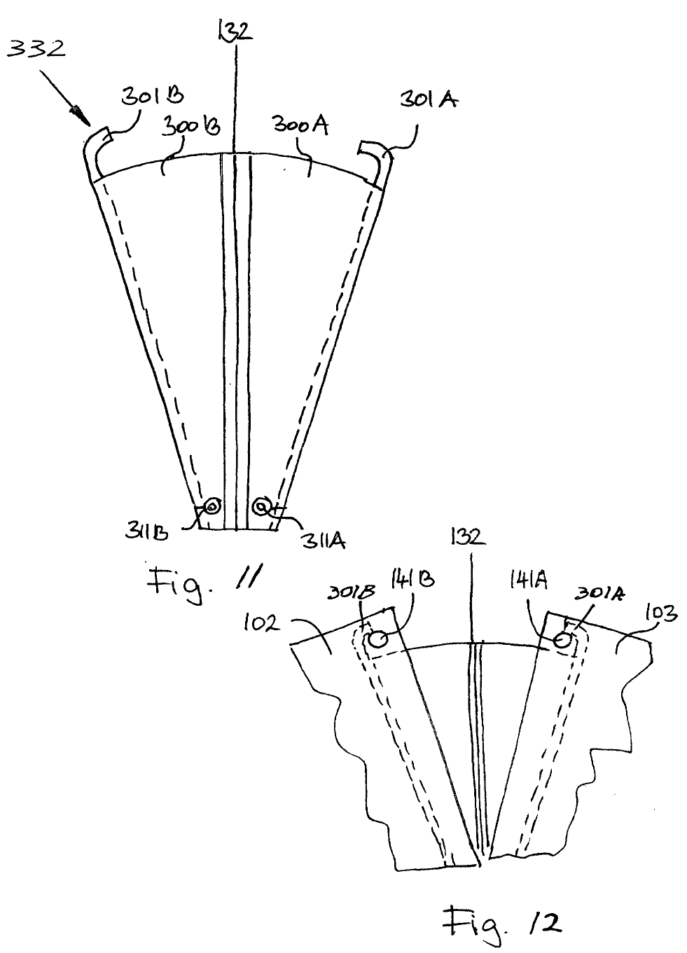

FIG. 10 shows charger 100 of FIG. 9 in an exemplary configuration with all of the solar panels 102 to 109 rotated apart. Charger 100 with its hinge panels 331-337 can be deployed n a variety of geometric configurations, due to the ability to rotate one or more solar panels 101-109 as needed to position charger 100 to best fit the available space and maximize the number of solar panels exposed to the sun. In the fully rotated configuration of FIG. 10, end panels 101 and 109 can be connected together to provide additional stability using fasteners such as hook and loop or magnetic fasteners. Any of many different configurations between the linear arrangement of panels as in FIG. 2 and the circular arrangement of FIG. 10, such as FIG. 9 are possible, depending on the number of hinge panels rotated and the amount that each hinge panel is rotated.

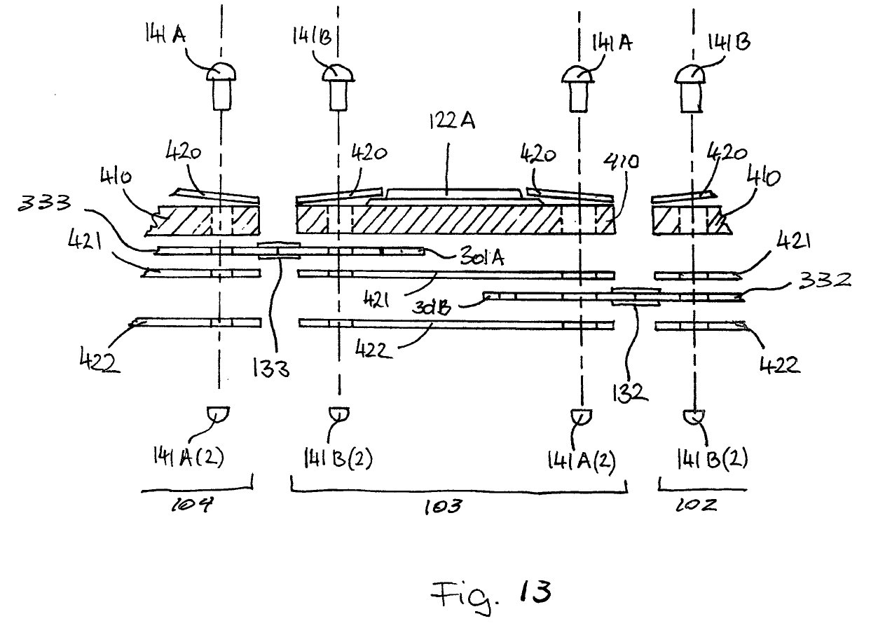

FIG. 11 shows an exemplary hinge panel 332 of charger 100 with hinge 132. Hinge panel 332 includes sections 300A and 300B on either side of hinge 132, hooks 301A and 301B and holes 31 1A and 311B. As can be seen from FIG. 10, hinge panel 332 is located between panels 102 and 103. As panel 103 is rotated away from panel 102, hinge panel 332 comes into view. Holes 311A and 311B are centers of rotation for respective panels 103 and 102, as they rotate away from each other. Hooks 301A and 301B engage fasteners in respective panels 103 and 102, and provide a limit or stop to the rotation of respective panels 103 and 102.

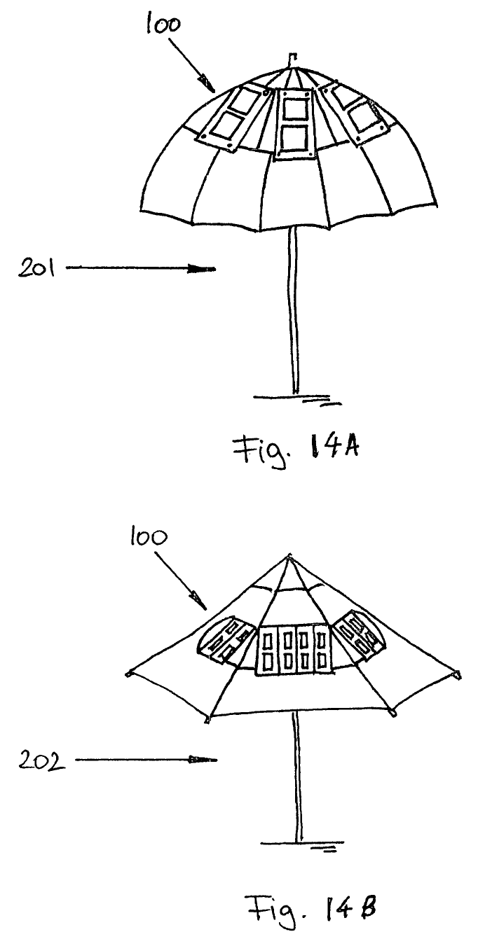

FIG. 12 shows a partial view of hinge panel 332 between two solar panels 102 and 103 of charger 100. As panel 103 is rotated away from panel 102 and hinge panel 332 comes into view, hook 301A engages with fastener 141A on panel 103 and hook 301B engages with fastener 141B on panel 102.

FIG. 13 shows a cross sectional view of solar panel 103 and two adjacent solar panels 102 and 104. The structure of panel 103 shown in FIG. 13 is an example of the construction of any of panels 102 to 109. The mechanical structure of panel 103 is primarily made of several layers: base 420, inner panel 421 and bottom panel 422. Panel 103 is connected to adjacent panels 102 and 104 by respective hinge panels 332 and 333. Panel 103 is made of base 410 to which are attached solar cells 122A and 122B (not visible in FIG. 13), using, for example, glue or an adhesive. The edges of solar cell 122A and 122B are protected by molding 420, which can function as a frame around solar cells 122A and 122B. Below base 410 is hinge panel 333, which includes hinge 133. Beneath hinge panel 333 is inner panel 421. Below inner panel 421 is hinge panel 332, which includes hinge 132. Under hinge panel 332 is bottom panel 422. Layers 410, 421 and 422 can be made of any of a variety of sheet material such as nylon, polyethylene or other plastic.

Panels 420, 421 and 422 of panel 103 are held together by fasteners 141A, 141B, 141C and 141D. Fasteners 141C and 141D are not shown in FIG. 13. Fasteners 141A-D are held in place by parts 141A(2)-D(2). The type of fastener used for 141A, which could be a screw or a rivet, will determine the kind of part 141A(2), such as a nut or a washer, that will mate with and keep fastener 141A locked in position. Fasteners 141A-D are locked in position to hold the layers of panel 103 together, but also provide some uncompressed space between the layers to enable hinge layers 332 and 333 to slide on the adjacent layers of 103, when panel 103 is rotated away from adjacent panels 102 or 104.

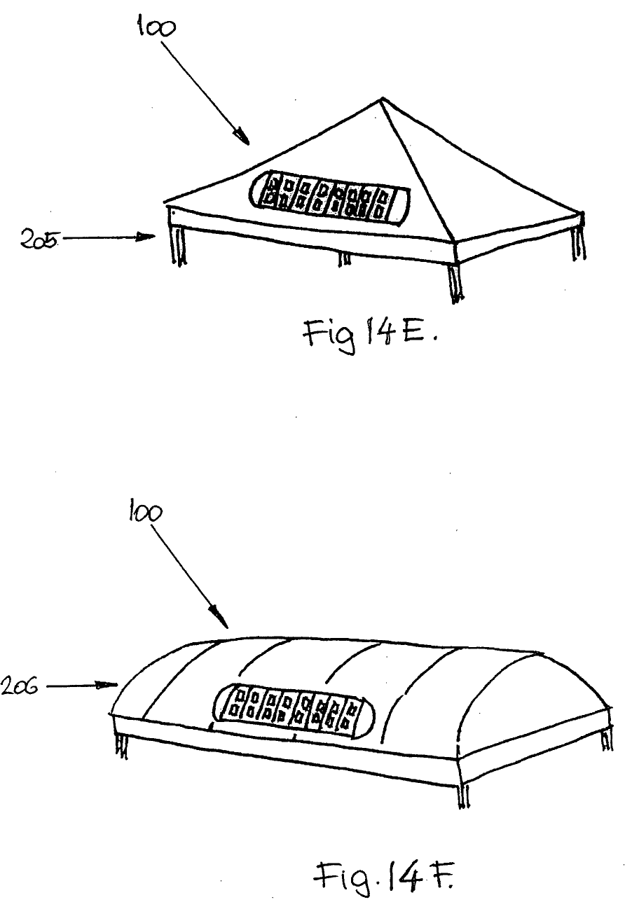

FIGS. 14A to 14F are exemplary deployments of charger 100 in a variety of different geometric configurations. FIG. 14A shows charger 100 deployed on top of an umbrella 201. FIG. 14B shows charger 100 positioned on top of a larger umbrella 202. FIG. 14C shows a fully rotated charger 100 placed on the top of a canopy 203. FIG. 14D shows a top view of a charger 100 located on top of a circular canopy 204. FIG. 14E shows an unfolded charger 100 on one side of the top of a canopy 205. FIG. 14F shows an unfolded charger 100 on the top of a canopy 206.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents.

We claim:

1. A portable solar battery charger comprising:
a plurality of solar panels connected by hinges, where the plurality of panels fold and unfold in an accordion pleated manner; and
a plurality of telescoping legs, where each of the plurality of legs can be configured to be extended from the charger in a direction parallel to an adjacent hinge and locked at a selected length.

2. The charger of claim 1, wherein each of the plurality of legs further comprises a spring for extending a leg from a stored position in the charger.

3. The charger of claim 1, wherein a first and second leg of the plurality of legs extend from opposite ends of a proximal solar panel and a third and fourth leg of the plurality of legs extend from opposite ends of a distal solar panel.

4. The charger of claim 1, and further comprising each of the plurality of solar panels including at least one solar cell coupled to a panel output terminal; and;
a multiposition switch for coupling a selected set of panel output terminals to a charger output terminal.

5. The charger of claim 4, wherein each of the positions of the multiposition switch corresponds to a selected set of solar panels to receive light irradiation.

6. The charger of claim 4, wherein at least one of the positions of the multiposition switch can couple the plurality of panel output terminals in an electrical configuration selected from the group consisting of: series, parallel and series/parallel.

7. The charger of claim 4, wherein at least one of the positions of the multiposition switch can couple the plurality of panel output terminals in an electrical configuration to provide a selected voltage at the charger output terminal.

8. The charger of claim 4, and further comprising a rechargeable battery coupled to the charger output terminal.

9. The charger of claim 1, wherein at least one of the hinges further comprises a hinge panel, where the hinge panel comprises:
a hinge;
a first and second fastener to respective adjacent solar panels, where the hinge panel can be rotated about either the first or the second fastener; and
a first and second hook, each of which engages a first and second respective stop on the adjacent respective solar panels.

10. A portable solar battery charger comprising:
a plurality of solar panels connected by hinges, where the plurality of panels fold and unfold in an accordion pleated manner and each of the plurality of solar panels includes at least one solar cell coupled to a panel output terminal; and
a multiposition switch for coupling a selected set of panel output terminals to a charger output terminal.

11. The charger of claim 10, wherein each of the positions of the multiposition switch corresponds to a selected set of solar panels to receive light irradiation.

12. The charger of claim 10, wherein at least one of the positions of the multiposition switch can couple the plurality of panel output terminals in an electrical configuration selected from the group consisting of: series, parallel and series/parallel.

13. The charger of claim 10, wherein at least one of the positions of the multiposition switch can couple the plurality of panel output terminals in an electrical configuration to provide a selected voltage at the charger output terminal.

14. The charger of claim 10, and further comprising a rechargeable battery coupled to the charger output terminal.

15. The charger of claim 10, and further comprising a plurality of telescoping legs, where each of the plurality of legs can be configured to be extended from the charger in a direction parallel to a hinge and positioned at a desired length.

16. The charger of claim 15, wherein each of the plurality of legs further comprises a spring for extending a leg from a stored position in the charger.

17. The charger of claim 15, wherein a first and second leg of the plurality of legs extend from opposite ends of a proximal solar panel and a third and fourth leg of the plurality of legs extend from opposite ends of a distal solar panel.

18. The charger of claim 1, wherein at least one of the hinges further comprises a hinge panel, where the hinge panel comprises:
a hinge;
a first and second fastener to respective adjacent solar panels, where the hinge panel can be rotated about either the first or the second fastener; and
a first and second hook, each of which engages a first and second respective stop on the adjacent respective solar panel.

19. A portable solar battery charger comprising:
a plurality of solar panels connected by hinge panels, where each of the hinge panels comprises:
a hinge;
a first and second fastener to respective adjacent solar panels, where a hinge panel can be rotated about either the first or the second fastener; and
a first and second hook, each of which can engage a first and second respective stop on the adjacent respective solar panels;
where the plurality of solar panels fold and unfold in an accordion pleated manner and after the unfolding of the charger, at least one of the plurality of hinge panels can be rotated about a selected fastener.

20. The charger of claim 19, wherein each of the plurality of panels is rotated away from each adjacent panel to configure the charger into a substantially circular shape.

21. The charger of claim 19, wherein the first and the second stop comprise respectively a third and fourth fastener.

22. The charger of claim 19, and further comprising each of the plurality of solar panels includes at least one solar cell coupled to a panel output terminal; and
a multiposition switch for coupling a selected set of panel output terminals to a charger output terminal.

23. The charger of claim 22, wherein each of the positions of the multiposition switch corresponds to a selected set of solar panels to receive light irradiation.

24. The charger of claim 22, wherein at least one of the positions of the multiposition switch can couple the plurality of panel output terminals in an electrical configuration selected from the group consisting of: series, parallel and series/parallel.

25. The charger of claim 22, wherein at least one of the positions of the multiposition switch can couple the plurality of panel output terminals in an electrical configuration to provide a selected voltage at the charger output terminal.

26. The charger of claim 22, and further comprising a rechargeable battery coupled to the charger output terminal.

27. The charger of claim 19, and further comprising a plurality of telescoping legs, where each of the plurality of legs can be configured to be extended from the charger in a direction parallel to a hinge and positioned at a desired length.

28. The charger of claim 27, wherein each of the plurality of legs further comprises a spring for extending a leg from a stored position in the charger.

29. The charger of claim 27, wherein a first and second leg of the plurality of legs extend from opposite ends of a proximal solar panel and a third and fourth leg of the plurality of solar panels extend from opposite ends of a distal solar panel.
